(19) United States
(12) Patent Application Publication
(10) Pub. No.: US 2026/0260647 A1
(43) Pub. Date: Sep. 3, 2026

(54) TRAINING DATA GENERATION APPARATUS, TRAINING DATA GENERATION METHOD, AND NON-TRANSITORY COMPUTER-READABLE MEDIUM

(71) Applicant: NEC Corporation, Minato-ku, Tokyo (JP)

(72) Inventors: Yuka ENJOJI, Tokyo (JP); Akira GOTOH, Tokyo (JP); Shuji KOMEIJI, Tokyo (JP); Yuko NAKANISHI, Tokyo (JP)

(73) Assignee: NEC Corporation, Minato-ku, Tokyo (JP)

(21) Appl. No.: 18/873,387

(22) PCT Filed: Jun. 29, 2023
(86) PCT No.: PCT/JP2023/024217

§ 371 Date: Dec. 10, 2024

(30) Foreign Application Priority Data
Jul. 4, 2022 (JP) 2022-107582

(51) Int. Cl. G10L 15/06; G10L 15/26

(52) U.S. Cl. CPC G10L 15/063; G10L 15/26

(57) ABSTRACT

A training data generation apparatus (10) includes a voice recognition unit (140) and a generation unit (160). The voice recognition unit (140) generates text information by inputting voice data into an already trained first voice recognition model. The generation unit (160) generates training data including the voice data and the text information. The first voice recognition model is a model that has been trained by use of a synthetic sound generated by use of input information relating to a predetermined item and previously prepared formatted text information.

### TECHNICAL FIELD

The present invention relates to a training data generation apparatus, a voice recognition model generation apparatus, a training data generation method, a voice recognition model generation method, and a medium.

### BACKGROUND ART

In order to acquire a trained model for performing voice recognition, it is necessary to prepare a lot of training data.

Patent Document 1 describes that as voice data for use in training of a voice recognition system, synthetic voice of an optimal sentence example for an additional word is generated. Moreover, Patent Document 1 describes that an optimal sentence example is generated by use of a sentence example template.

Patent Document 2 describes that speech voice of a user is recognized by use of a recognition engine that has been trained with training data for each user, and training data including the speech voice and a recognition result are generated.

### RELATED DOCUMENTS

### Patent Documents

Patent Document 1: International Patent Publication No. WO2021/215352

Patent Document 2: International Patent Publication No. WO2021/059968

### SUMMARY

### Technical Problem

In Patent Document 1 described above, synthetic voice generated by a program is determined as voice data used for training in a system that performs voice recognition of human voice. Therefore, there is a problem in that training using the voice data has a limited improvement in recognition accuracy. Moreover, since Patent Document 2 described above describes generating training data for each user, there is a problem that it is difficult to improve recognition accuracy in voice recognition irrespective of user.

In view of the problem described above, one example of an object of the present invention is to provide a training data generation apparatus, a voice recognition model generation apparatus, a training data generation method, a voice recognition model generation method, and a medium that improve recognition accuracy of a voice recognition model.

### Solution to Problem

According to an example aspect of the present invention, there is provided a training data generation apparatus including:
a voice recognition unit that generates text information by inputting voice data into an already trained first voice recognition model; and
a generation unit that generates training data including the voice data and the text information, in which
the first voice recognition model is a model that has been trained by use of a synthetic sound generated by use of input information relating to a predetermined item and previously prepared formatted text information.

According to an example aspect of the present invention, there is provided a training data generation apparatus including:
a voice recognition unit that inputs voice data into each of an already trained first voice recognition model and a second voice recognition model, and thereby generates an output result of each of the first voice recognition model and the second voice recognition model;
a determination unit that determines whether there is a difference between the output result of the first voice recognition model and the output result of the second voice recognition model; and
a generation unit that generates training data including the voice data in a case where the determination unit determines that there is a difference between the output result of the first voice recognition model and the output result of the second voice recognition model.

According to an example aspect of the present invention, there is provided a voice recognition model generation apparatus including
training the second voice recognition model by use of the training data generated by the above-described training data generation apparatus.

According to an example aspect of the present invention, there is provided a training data generation method including,
by one or more computers:
   generating text information by inputting voice data into an already trained first voice recognition model; and
   generating training data including the voice data and the text information, in which
the first voice recognition model is a model that has been trained by use of a synthetic sound generated by use of input information relating to a predetermined item and previously prepared formatted text information.

According to an example aspect of the present invention, there is provided a training data generation method including,
by one or more computers:
   inputting voice data into each of an already trained first voice recognition model and a second voice recognition model, and thereby generating an output result of each of the first voice recognition model and the second voice recognition model;
   determining whether there is a difference between the output result of the first voice recognition model and the output result of the second voice recognition model; and
   generating training data including the voice data in a case where it is determined that there is a difference between the output result of the first voice recognition model and the output result of the second voice recognition model.

According to an example aspect of the present invention, there is provided a voice recognition model generation method including,
by one or more computers,
training the second voice recognition model by use of the training data generated by the above-described training data generation method.

According to an example aspect of the present invention, there is provided a computer-readable medium storing a program, the program causing a computer to function as a training data generation apparatus, in which
the training data generation apparatus includes
   a voice recognition unit that generates text information by inputting voice data into an already trained first voice recognition model, and
   a generation unit that generates training data including the voice data and the text information, and
the first voice recognition model is a model that has been trained by use of a synthetic sound generated by use of input information relating to a predetermined item and previously prepared formatted text information.

According to an example aspect of the present invention, there is provided a computer-readable medium storing a program, the program causing a computer to function as a training data generation apparatus, in which
the training data generation apparatus includes
   a voice recognition unit that inputs voice data into each of an already trained first voice recognition model and a second voice recognition model, and thereby generates an output result of each of the first voice recognition model and the second voice recognition model,
   a determination unit that determines whether there is a difference between the output result of the first voice recognition model and the output result of the second voice recognition model, and
   a generation unit that generates training data including the voice data in a case where the determination unit determines that there is a difference between the output result of the first voice recognition model and the output result of the second voice recognition model.

According to an example aspect of the present invention, there is provided a computer-readable medium storing a program, the program causing a computer to function as a voice recognition model generation apparatus, in which
the voice recognition model generation apparatus trains the second voice recognition model by use of the training data generated by the training data generation apparatus achieved by the program recorded in the medium.

### Advantageous Effects of Invention

According to an example aspect of the present invention, a training data generation apparatus, a voice recognition model generation apparatus, a training data generation method, a voice recognition model generation method, and a medium that improve recognition accuracy of a voice recognition model are acquired.

### BRIEF DESCRIPTION OF THE DRAWINGS

FIG. 1 It is a diagram illustrating an outline of a training data generation apparatus according to a first example embodiment.

FIG. 2 It is a diagram illustrating an outline of a first voice recognition model.

FIG. 3 It is a diagram illustrating an outline of a generation method of the first voice recognition model.

FIG. 4 It is a diagram illustrating a functional configuration of the training data generation apparatus according to the first example embodiment.

FIG. 5 It is a diagram illustrating an outline of a method by which a first model generation unit generates the first voice recognition model.

FIG. 6 It is a diagram illustrating a functional configuration of a voice recognition model generation apparatus according to the first example embodiment.

FIG. 7 It is a diagram illustrating a computer for achieving a training data generation apparatus.

FIG. 8 It is a diagram illustrating an outline of a training data generation method according to the first example embodiment.

FIG. 9 It is a flowchart illustrating a flow of the training data generation method according to the first example embodiment.

FIG. 10 It is a diagram illustrating an outline of a training data generation apparatus according to a second example embodiment.

FIG. 11 It is a diagram illustrating a functional configuration of the training data generation apparatus according to the second example embodiment.

FIG. 12 It is a diagram illustrating an outline of a training data generation method according to the second example embodiment.

FIG. 13 It is a flowchart illustrating a flow of the training data generation method according to the second example embodiment.

### EXAMPLE EMBODIMENT

Hereinafter, example embodiments according to the present invention are described by use of the drawings. Note that, in all the drawings, a similar component is assigned with a similar reference sign, and description thereof is omitted as appropriate.

### First Example Embodiment

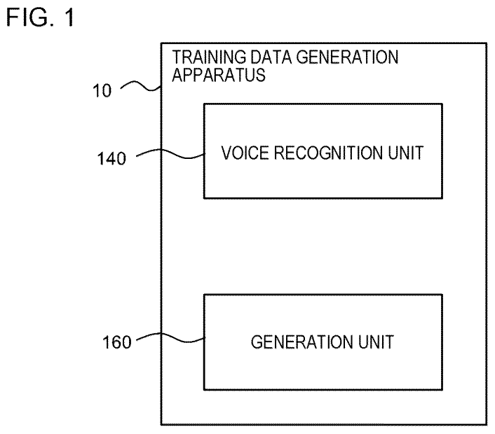

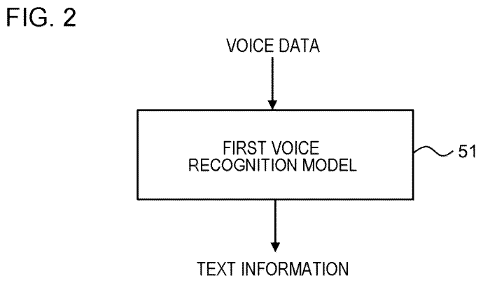

FIG. 1 is a diagram illustrating an outline of a training data generation apparatus 10 according to the first example embodiment. FIG. 2 is a diagram illustrating an outline of a first voice recognition model 51. The training data generation apparatus 10 includes a voice recognition unit 140 and a generation unit 160. The voice recognition unit 140 generates text information by inputting voice data into the trained first voice recognition model 51. The generation unit 160 generates training data including voice data and text information. The first voice recognition model 51 is a model that has been trained by use of a synthetic sound generated by use of input information relating to a predetermined item and previously prepared formatted text information.

The training data generation apparatus 10 can improve recognition accuracy of a voice recognition model.

Hereinafter, a detailed example of the training data generation apparatus 10 according to the present example embodiment is described.

In the present example embodiment, the voice data are data acquired by recording a speech of a person. That is to say, voice data are not so-called data of a synthetic sound artificially generated by a machine or the like. Moreover, voice data are data indicating a voice waveform, or data indicating a feature value of a voice waveform. Voice data are data acquired by recording, for example, call voice in a voice call or a video call. As a specific example, voice data are data acquired by recording call voice for a dispatch request for an emergency vehicle (e.g. police, a fire engine, or an ambulance). As another example, voice data may be data acquired by recording call voice in various call centers. One piece of voice data may be generated for an entire call, or a plurality of pieces of voice data may be generated by dividing an entire call into a plurality of parts. However, voice data are not limited to data acquired by recording a call.

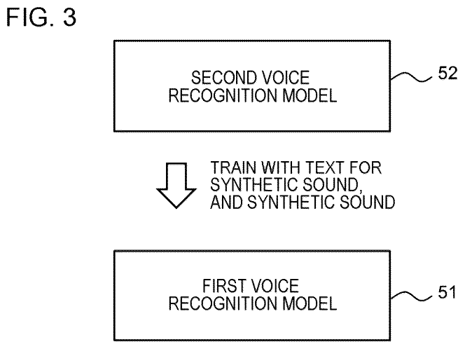

FIG. 3 is a diagram illustrating an outline of a generation method of the first voice recognition model 51. Both the first voice recognition model 51 and the second voice recognition model 52 are voice recognition models acquired by machine learning. As illustrated in FIG. 2, the first voice recognition model 51 is a trained model capable of converting voice data into text information indicating a content being relevant to the voice data. In other words, input data of the first voice recognition model 51 include voice data, and output data of the first voice recognition model 51 include text information. Then, the first voice recognition model 51 is a model generated by training the second voice recognition model 52 by use of a synthetic sound.

Similarly to the first voice recognition model 51, the second voice recognition model 52 is a model capable of converting voice data into text information indicating a content being relevant to the voice data. Moreover, the second voice recognition model 52 is a model that has been trained by use of a plurality of pieces of training data including voice data and text information indicating a content being relevant to the voice data. The second voice recognition model 52 is preferably a model that has not been trained by use of a synthetic sound. However, the second voice recognition model 52 may be a model that has been trained by use of a synthetic sound as a part of training.

That is to say, the first voice recognition model 51 can be, as a whole of a training history, a model that has been trained by use of both one or more pieces of training data including voice data other than a synthetic sound and one or more pieces of training data including a synthetic sound. The first voice recognition model 51 may be a model that has been trained with at least one piece of training data including a synthetic sound. Among a plurality of pieces of training data used for training of the first voice recognition model 51, the number of pieces of training data including a synthetic sound may be only one. The synthetic sound is described in detail later.

Due to training using a synthetic sound, it is expected that the first voice recognition model 51 becomes higher in voice recognition accuracy than the second voice recognition model 52. The voice recognition unit 140 of the training data generation apparatus 10 inputs voice data into the first voice recognition model 51, and thus causes the first voice recognition model 51 to output text information. Then, the generation unit 160 generates, as training data, data associating the voice data input into the first voice recognition model 51 with the text information output from the first voice recognition model 51. The voice data included in the training data are not a synthetic sound as described above, but are recorded data of a speech by an actual person. While a synthetic sound differs from an actual speech in a clausal feature, a prosodic feature, a frequency characteristic, and the like, the training data generation apparatus 10 according to the present example embodiment generates training data including recorded data of a speech by an actual person. Therefore, training data by the training data generation apparatus 10 according to the present example embodiment enables training reflecting the features, and, in consequence, a voice recognition model being higher in recognition accuracy is achieved.

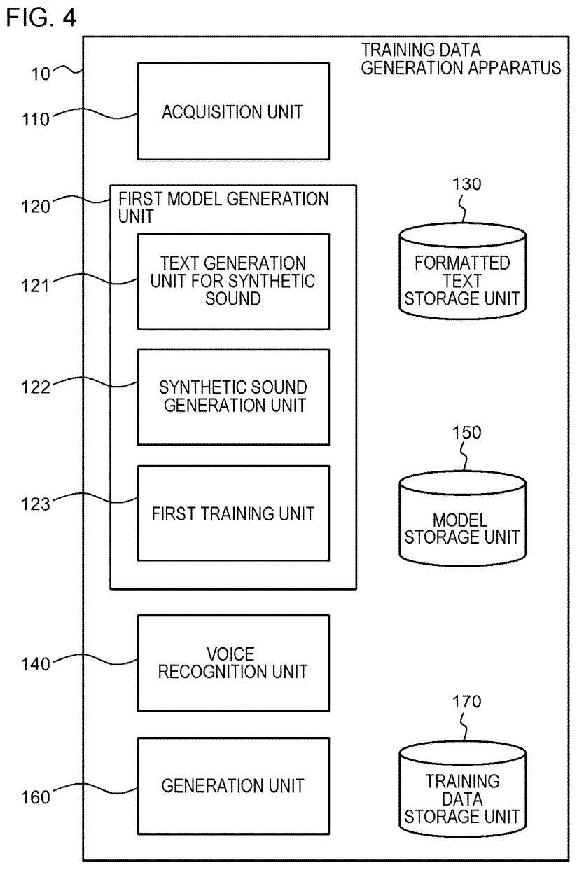

FIG. 4 is a diagram illustrating a functional configuration of the training data generation apparatus 10 according to the present example embodiment. In the example of the present figure, the training data generation apparatus 10 further includes an acquisition unit 110, a first model generation unit 120, a formatted text storage unit 130, a model storage unit 150, and a training data storage unit 170. Moreover, in the example of the present figure, the first model generation unit 120 includes a text generation unit for a synthetic sound 121, a synthetic sound generation unit 122, and a first training unit 123. Note that, one or more of the formatted text storage unit 130, the model storage unit 150, and the training data storage unit 170 may be a storage apparatus provided outside the training data generation apparatus 10. Each functional configuration unit of the training data generation apparatus 10 is described in detail below.

The acquisition unit 110 acquires input information and voice data associated with each other. The input information is relevant to a content of a speech of the voice data associated with the input information. For example, in a case where voice data are acquired by recording a call, input information is generated as follows. For example, a recipient of a call (inputting person) inputs a call content into a terminal while having the call. For example, on a terminal, a plurality of items to be input are presented to the inputting person, and an input operation is performed by filling in an input field for each item. Accordingly, input information indicating an input call content is generated. As another example, an operator who performs information input may input a call content into a terminal after a call ends, and, thereby, input information may be generated.

For example, an identification ID is attached to voice data of each call, and, by associating the identification ID of the call with input information, the input information and voice data are associated. Note that, input information may include the identification ID of the voice data. As another example, input information may be associated with voice data by including, in the input information, an identification ID of a receiving terminal of a call and a receiving date and time. In this case, information indicating an identification ID of the receiving terminal and a recording date and time (i.e. a receiving date and time) is attached to the voice data.

An item included in input information is relevant to an item to be input into the terminal described above. A plurality of items included in the input information may include, for example, one or more of “name of call partner”, “address”, “telephone number”, and “item relating to business”. For example, in a case where a call is a call for a dispatch request of an emergency vehicle (e.g. police, a fire engine, or an ambulance), the “item relating to business” may include the “type of event” (e.g., which of an incident, an accident, a fire, and a sudden illness), “request location” (occurrence location of an accident, and the like), and the like. Herein, the “type of event” may be indicated by, for example, a previously determined number or symbol for each of an incident, an accident, a fire, sudden illness, and the like. For example, in a case where a call is a call for a dispatch request of an ambulance, the “item relating to business” may further include one or more of “bodily part”, “condition of injury or the like”, and “symptom”. An item included in input information may differ depending on the “type of event”. For example, in a case where the “type of event” is an incident or an accident, the “item relating to business” may include “situation of scene” (overturning of a car or the like). For example, in a case where a call is a call for an order of telephone shopping, the “item relating to business” may include “information indicating purchased product”, “quantity of purchase”, “delivery destination”, and the like. Note that, a content input for each item may be a sentence.

Such an input operation is normally performed within a scope of work of call reception, and does not need to be specially performed in order to cause the training data generation apparatus 10 to generate training data. Therefore, by using the training data generation apparatus 10, training data can be generated, and accuracy of a voice recognition model can be improved, without requiring special effort. However, input information is not limited to the example described above, and may be information that can generate a text for synthesis by applying a content of each item to formatted text information as described later. Input information may not necessarily be related to voice data acquired by the acquisition unit 110. In this case, a plurality of texts for synthesis and a plurality of synthetic sounds may be generated by use of a plurality of pieces of input information. The first voice recognition model 51 can be a model that has been trained by use of a plurality of synthetic sounds.

Although a method by which the acquisition unit 110 acquires input information and voice data is not particularly limited, for example, the acquisition unit 110 may acquire input information and voice data by reading from a storage apparatus holding the input information and the voice data. As another example, the acquisition unit 110 may directly acquire input information from a terminal into which a call content is input.

The acquisition unit 110 may acquire a plurality of pieces of voice data. The acquisition unit 110 may acquire voice data one by one each time voice data are generated, or may collectively acquire a plurality of pieces of voice data at a time. Then, the first model generation unit 120 preferably generates the first voice recognition model 51 for each piece of voice data acquired by the acquisition unit 110.

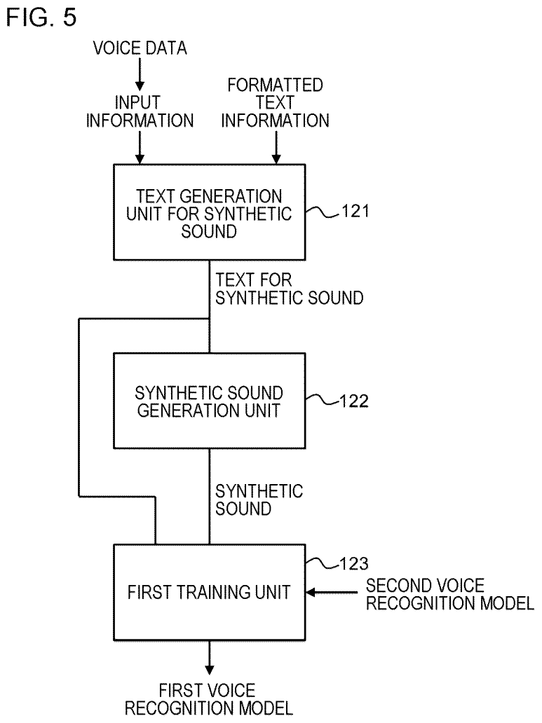

FIG. 5 is a diagram illustrating an outline of a method by which the first model generation unit 120 generates the first voice recognition model 51. The text generation unit for a synthetic sound 121 of the first model generation unit 120 acquires input information being relevant to, for example, any voice data. Moreover, the text generation unit for a synthetic sound 121 acquires formatted text information from the formatted text storage unit 130. Formatted text information is previously prepared and held in the formatted text storage unit 130. For example, formatted text information is information indicating a text of a formatted sentence such as “This is xx. An accident occurred at yy.”. The text generation unit for a synthetic sound 121 generates a text for a synthetic sound by applying input information to formatted text information.

Specifically, for example, the part of “xx” in “This is xx. An accident occurred at yy.” is replaced with a name indicated in the input information, and the part of “yy” is replaced with a request location indicated in the input information. Consequently, the text generation unit for a synthetic sound 121 can generate a text for a synthetic sound by use of the formatted text information and the input information.

Herein, the text generation unit for a synthetic sound 121 may select formatted text information to be used, from among a plurality of pieces of formatted text information held in the formatted text storage unit 130. For example, the formatted text storage unit 130 holds formatted text information for each type of event. Each piece of affiliation text information is associated with one of types of events. Then, the text generation unit for a synthetic sound 121 selects, as formatted text information to be used, formatted text information being relevant to a type of event indicated in input information. For example, formatted text information of “This is xx. An accident occurred at yy.” is selected in a case where a type of event is an accident, formatted text information of “This is xx. A fire occurred at yy.” is selected in a case where a type of event is a fire, and formatted text information of “This is xx. There is a person with a sudden illness in yy.” is selected in a case where a type of event is a sudden illness. Then, the text generation unit for a synthetic sound 121 generates a text for a synthetic sound by use of the selected formatted text information in a way similar to that described above.

The synthetic sound generation unit 122 acquires a text for a synthetic sound generated by the text generation unit for a synthetic sound 121, and converts the text for a synthetic sound into a synthetic sound. The synthetic sound is relevant to a content of the text for a synthetic sound, and is relevant to voice acquired by reading the text for a synthetic sound. An existing technique can be used for a method of converting a text for a synthetic sound into a synthetic sound. The text generation unit for a synthetic sound 121 can convert a text for a synthetic sound into a synthetic sound, by use of, for example, a trained model in which a text is an input and a synthetic sound is an output.

The first training unit 123 generates training data for generating the first voice recognition model 51, by associating a text for a synthetic sound generated by the text generation unit for a synthetic sound 121 with a synthetic sound generated by the synthetic sound generation unit 122. Then, the first training unit 123 generates the first voice recognition model 51 by training the second voice recognition model 52 by use of the generated training data. The second voice recognition model 52 is held in the model storage unit 150, and the first training unit 123 can read the second voice recognition model 52 from the model storage unit 150 and use the second voice recognition model 52 for generation of the first voice recognition model 51. The first voice recognition model 51 trained with the training data including the text for a synthetic sound and the synthetic sound is output to the voice recognition unit 140. In this way, the first model generation unit 120 can generate, by using input information, the first voice recognition model 51 in which recognition accuracy is improved without making effort.

Returning to FIG. 4, the voice recognition unit 140 acquires the first voice recognition model 51 generated by the first model generation unit 120. Then, voice data acquired by the acquisition unit 110 are input into the acquired first voice recognition model 51. Accordingly, text information being relevant to the voice data is generated as an output of the first voice recognition model 51.

The generation unit 160 generates training data associating the voice data acquired by the acquisition unit 110 with the text information generated by the voice recognition unit 140. The generation unit 160 causes the training data storage unit 170 to hold the generated training data, for example. However, the generation unit 160 may output the generated training data to an external apparatus instead.

Note that, the training data generation apparatus 10 may not include the acquisition unit 110 and the first model generation unit 120. In this case, the first voice recognition model 51 that has been previously trained by use of a synthetic sound is held in a storage apparatus accessible from the voice recognition unit 140, and the voice recognition unit 140 can read and use the first voice recognition model 51.

An effect of generating the first voice recognition model 51 for each piece of voice data as performed by the first model generation unit 120 is described below. The first voice recognition model 51 generated by the first model generation unit 120 as described above is considered to be particularly high in recognition accuracy with respect to voice data acquired by the acquisition unit 110. That is to say, it can be said that the first voice recognition model 51 trained with a synthetic sound based on input information associated with certain voice data k is a model particularly suitable for recognition of the voice data k. There is a high possibility that the first voice recognition model 51 as above can correctly recognize the voice data k. In other words, there is a high possibility that text information acquired by inputting the voice data k into the first voice recognition model 51 as above correctly indicates a speech content of the voice data k. Thus, the text information can be preferably used as correct answer data of training data. Note that, the first voice recognition model 51 may be deleted after generating correct answer data regarding the voice data k. For another piece of voice data k+1, the first voice recognition model 51 may be newly generated.

The training data generated by the training data generation apparatus 10 is preferably used for training of the second voice recognition model 52, but may also be used for training of a voice recognition model other than the second voice recognition model 52.

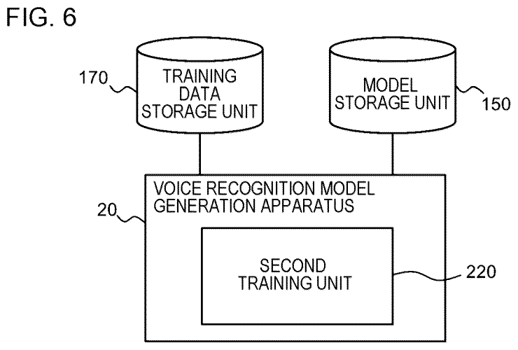

FIG. 6 is a diagram illustrating a functional configuration of the voice recognition model generation apparatus 20 according to the present example embodiment. The voice recognition model generation apparatus 20 trains the second voice recognition model 52 by use of training data generated by the training data generation apparatus 10. As described above, the first voice recognition model 51 is expected to be higher in recognition accuracy than the second voice recognition model 52. Therefore, by using training data in which text information generated by the first voice recognition model 51 is correct answer data, voice recognition accuracy of the second voice recognition model 52 can be improved. Moreover, since the second voice recognition model 52 can be trained using voice data that are not a synthetic sound, recognition accuracy for an actual speech can be heightened more.

In the example of the present figure, the voice recognition model generation apparatus 20 includes a second training unit 220. The second training unit 220 acquires the second voice recognition model 52 from the model storage unit 150, and acquires, from the training data storage unit 170, training data generated by the training data generation apparatus 10. Then, the second training unit 220 trains, using the acquired training data, the second voice recognition model 52 and thereby can generate the second voice recognition model 52 with more improved recognition accuracy. The voice recognition model generation apparatus 20 may acquire training data each time the training data generation apparatus 10 generates the training data, or, after a plurality of pieces of training data are generated by the training data generation apparatus 10 and held in the training data storage unit 170, the voice recognition model generation apparatus 20 may collectively acquire the pieces of training data.

The voice recognition model generation apparatus 20 may update, with the second voice recognition model 52 after trained, the second voice recognition model 52 held in the model storage unit 150. The updated second voice recognition model 52 is utilizable again by the training data generation apparatus 10 for generation of the first voice recognition model 51.

The voice recognition model generation apparatus 20 may be integrated with the training data generation apparatus 10, or may be a separate apparatus from the training data generation apparatus 10.

The voice recognition model generation apparatus 20 according to the present example embodiment executes a voice recognition model generation method that trains, by one or more computers, the second voice recognition model 52 by use of training data generated by the training data generation apparatus 10.

A hardware configuration of the training data generation apparatus 10 is described below. Each functional configuration unit of the training data generation apparatus 10 may be achieved by hardware that achieves each functional configuration unit (example: a hardwired electronic circuit or the like), or may be achieved by a combination of hardware and software (example: a combination of an electronic circuit and a program that controls the electronic circuit). Hereinafter, a case where each functional configuration unit of the training data generation apparatus 10 is achieved by a combination of hardware and software is further described.

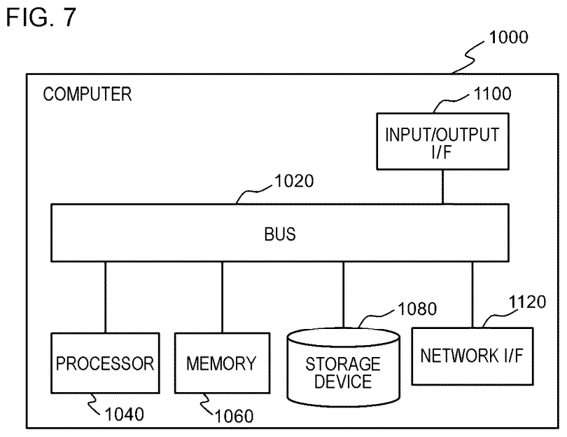

FIG. 7 is a diagram illustrating a computer 1000 for achieving the training data generation apparatus 10. The computer 1000 is any computer. For example, the computer 1000 is a system on chip (SoC), a personal computer (PC), a server machine, a tablet terminal, a smartphone, or the like. The computer 1000 may be a dedicated computer designed in order to achieve the training data generation apparatus 10, or may be a general-purpose computer. Moreover, the training data generation apparatus 10 may be achieved by one computer 1000, or may be achieved by a combination of a plurality of the computers 1000.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to mutually transmit and receive data. However, a method of connecting the processor 1040 and the like to each other is not limited to bus connection. The processor 1040 is a variety of processors such as a central processing unit (CPU), a graphics processing unit (GPU), or a field-programmable gate array (FPGA). The memory 1060 is a main storage device achieved by use of a random access memory (RAM) and the like. The storage device 1080 is an auxiliary storage device achieved by use of a hard disk, a solid state drive (SSD), a memory card, a read only memory (ROM), and the like.

The input/output interface 1100 is an interface for connecting the computer 1000 and an input/output device. For example, an input device such as a keyboard, and an output device such as a display are connected to the input/output interface 1100. A method in which the input/output interface 1100 is connected to the input device and the output device may be wireless connection, or may be wired connection.

The network interface 1120 is an interface for connecting the computer 1000 to a network. The communication network is, for example, a local area network (LAN) or a wide area network (WAN). A method in which the network interface 1120 is connected to a network may be wireless connection, or may be wired connection.

The storage device 1080 stores a program module that achieves each functional configuration unit of the training data generation apparatus 10. The processor 1040 reads each of the program modules onto the memory 1060, executes the read program module, and thereby achieves a function being relevant to each of the program modules. Moreover, in a case where the formatted text storage unit 130, the model storage unit 150, and the training data storage unit 170 are each provided inside the training data generation apparatus 10, the formatted text storage unit 130, the model storage unit 150, and the training data storage unit 170 are achieved by the storage device 1080.

The hardware configuration of a computer that achieves the voice recognition model generation apparatus 20 according to the present example embodiment is represented by, for example, FIG. 7, similarly to the training data generation apparatus 10. However, the storage device 1080 of the computer 1000 that achieves the voice recognition model generation apparatus 20 stores a program module that achieves a function of the voice recognition model generation apparatus 20.

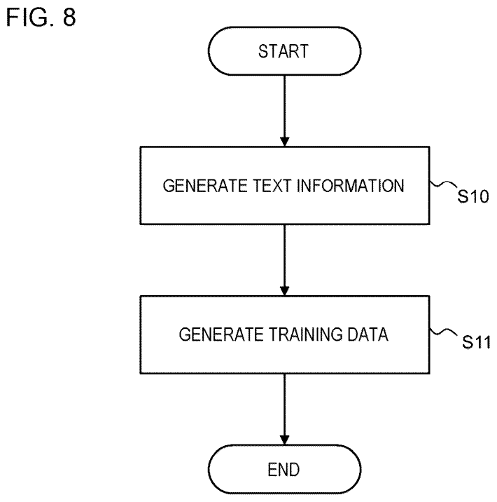

FIG. 8 is a diagram illustrating an outline of a training data generation method according to the present example embodiment. The training data generation method according to the present example embodiment is executed by one or more computers. The training data generation method according to the present example embodiment includes a voice recognition step S10 and a generation step S11. In the voice recognition step S10, text information is generated by inputting voice data into the trained first voice recognition model 51. In the generation step S11, training data including voice data and text information are generated. The first voice recognition model 51 is a model that has been trained by use of a synthetic sound generated by use of input information relating to a predetermined item and previously prepared formatted text information.

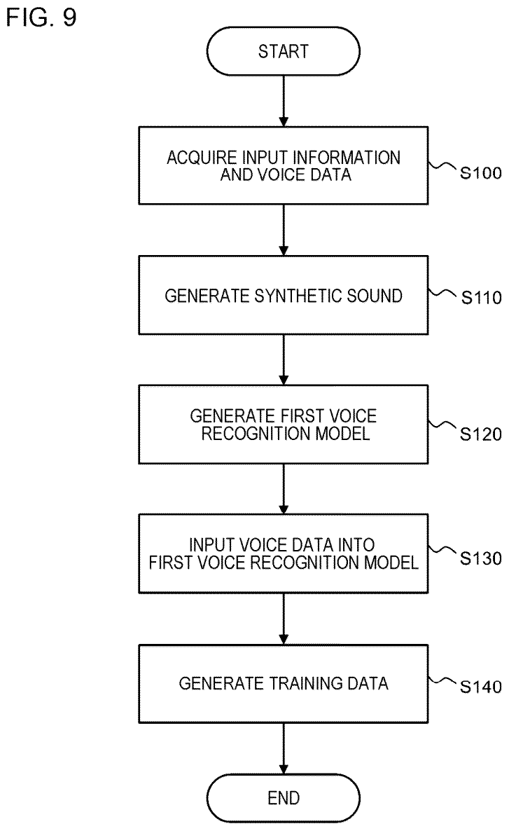

FIG. 9 is a flowchart illustrating a flow of the training data generation method according to the present example embodiment. In the training data generation method according to the present example embodiment, the acquisition unit 110 acquires input information and voice data associated with each other (S100). Subsequently, the text generation unit for a synthetic sound 121 generates a text for a synthetic sound by use of the input information and formatted text information, and the synthetic sound generation unit 122 further generates a synthetic sound by use of the text for a synthetic sound (S110). Subsequently, the first training unit 123 trains the second voice recognition model 52 by use of the text for a synthetic sound and the synthetic sound, and thereby generates the first voice recognition model 51 (S120). Subsequently, the voice recognition unit 140 inputs the voice data into the first voice recognition model 51, and text information is thereby generated (S130). Then, the generation unit 160 generates training data including voice data and text information in a state of being associated with each other (S140). Processing from S100 to S140 is performed, for example, for each piece of voice data.

As described above, according to the present example embodiment, the voice recognition unit 140 generates text information by inputting voice data into the trained first voice recognition model 51. The generation unit 160 generates training data including voice data and text information. The first voice recognition model 51 is a model that has been trained by use of a synthetic sound generated by use of input information and previously prepared formatted text information. Therefore, training data including voice data can be easily generated by use of the first voice recognition model 51 heightened in accuracy by use of a synthetic sound. In consequence, a voice recognition model being high in recognition accuracy is achieved.

### Second Example Embodiment

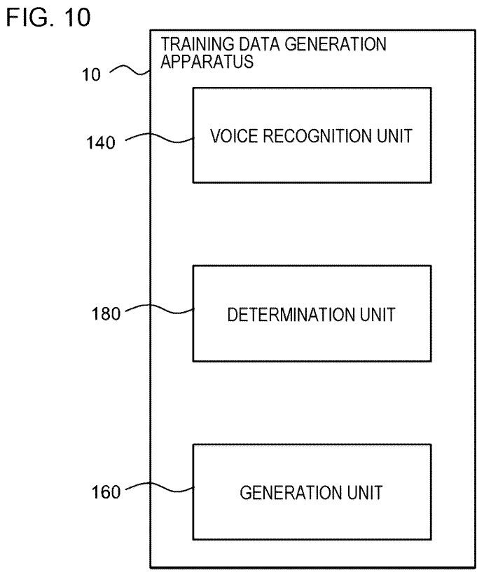

FIG. 10 is a diagram illustrating an outline of a training data generation apparatus 10 according to the second example embodiment. The training data generation apparatus 10 according to the present example embodiment includes a voice recognition unit 140, a determination unit 180, and a generation unit 160. The voice recognition unit 140 inputs voice data into each of an already trained first voice recognition model and a second voice recognition model, and thereby generates an output result of each of the first voice recognition model and the second voice recognition model. The determination unit 180 determines whether there is a difference between the output result of the first voice recognition model and the output result of the second voice recognition model. The generation unit 160 generates training data including the voice data in a case where the determination unit 180 determines that there is a difference between the output result of the first voice recognition model and the output result of the second voice recognition model.

The training data generation apparatus 10 according to the present example embodiment can improve recognition accuracy of a voice recognition model.

Hereinafter, a detailed example of the training data generation apparatus 10 according to the present example embodiment is described. However, the training data generation apparatus 10 according to the present example embodiment is not limited to the following example.

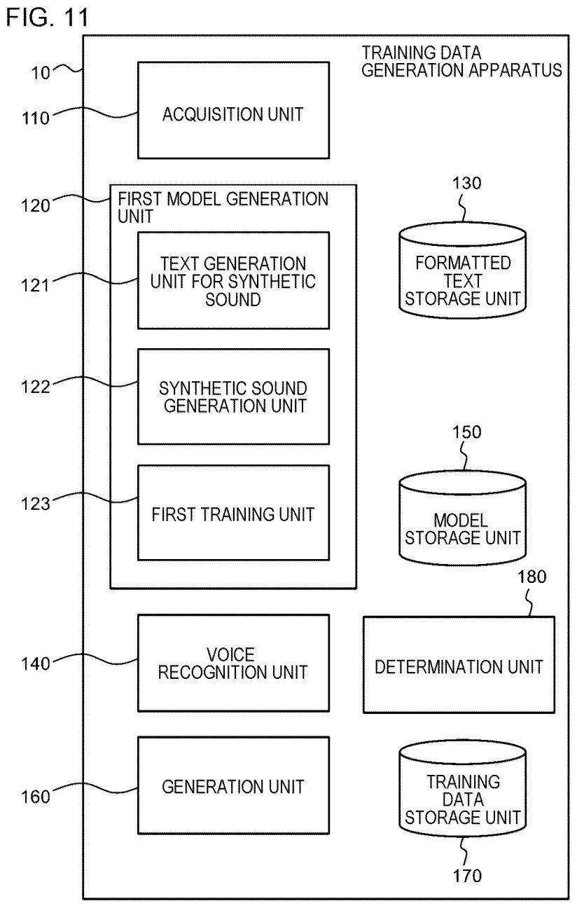

FIG. 11 is a diagram illustrating a functional configuration of the training data generation apparatus 10 according to the present example embodiment. The training data generation apparatus 10 according to the present example embodiment is the same as the training data generation apparatus 10 according to the first example embodiment except for a point described below.

In the present example embodiment, in a case where the first voice recognition model 51 is generated by the first model generation unit 120, the voice recognition unit 140 inputs voice data acquired by the acquisition unit 110 into the generated first voice recognition model 51, similarly to the first example embodiment. Moreover, the voice recognition unit 140 inputs, into the second voice recognition model 52 read from the model storage unit 150, the same voice data as those input into the first voice recognition model 51. Then, text information being an output result is acquired from each of the first voice recognition model 51 and the second voice recognition model 52.

However, the training data generation apparatus 10 may not include the acquisition unit 110 and the first model generation unit 120. In this case, the voice recognition unit 140 reads and acquires the first voice recognition model 51 and the second voice recognition model 52 previously stored in a storage device accessible from the voice recognition unit 140. However, the first voice recognition model 51 is a model being higher in voice recognition accuracy than the second voice recognition model 52.

The determination unit 180 compares the text information being an output result of the first voice recognition model 51 and the text information being an output result of the second voice recognition model 52 that are generated by the voice recognition unit 140. For example, in a case where the output result of the first voice recognition model 51 and the output result of the second voice recognition model 52 match, the determination unit 180 outputs, to the generation unit 160, determination result information indicating that there is no need to generate training data. In a case where the output result of the first voice recognition model 51 and the output result of the second voice recognition model 52 do not match, the determination unit 180 outputs, to the generation unit 160, determination result information indicating that training data are to be generated.

The generation unit 160 acquires the determination result information from the determination unit 180. In a case where the generation unit 160 acquires determination result information indicating that there is no need to generate training data, the generation unit 160 does not generate training data, and the training data generation apparatus 10 ends processing relating to the voice data. In a case where the generation unit 160 acquires determination result information indicating that training data are to be generated, the generation unit 160 generates training data. Specifically, the generation unit 160 generates training data associating the voice data acquired by the acquisition unit 110 with the text information generated by the voice recognition unit 140 and being an output result of the first voice recognition model 51. The generation unit 160 causes a training data storage unit 170 to hold the generated training data, for example. However, the generation unit 160 may output the generated training data to an external apparatus instead.

The training data generation apparatus 10 according to the present example embodiment generates training data including voice data only in a case where it is determined that there is a difference between an output result of the first voice recognition model 51 and an output result of the second voice recognition model 52. In a case where the same voice data are input, there is a possibility that, in a case where the output result of the first voice recognition model 51 and the output result of the second voice recognition model 52 are the same, both voice recognition models have performed correct output. Then, in the second voice recognition model 52, it is not very effective to further perform training using the voice data.

On the other hand, as described above in the first example embodiment, the first voice recognition model 51 is expected to be higher in recognition accuracy than the second voice recognition model 52. Therefore, in a case where the same voice data are input, there is a possibility that, in a case where an output result of the first voice recognition model 51 and an output result of the second voice recognition model 52 differ from each other, the output result of the first voice recognition model 51 is more accurate than the output result of the voice recognition model 52. Therefore, it is preferable to generate training data using the output result of the first voice recognition model 51. Training using the generated training data can improve recognition accuracy of the second voice recognition model 52.

In this way, the determination unit 180 determines whether there is a difference between an output result of a first voice recognition model and an output result of a second voice recognition model, and, thereby, training data that enable efficient training are generated.

A voice recognition model generation apparatus 20 according to the present example embodiment is the same as the voice recognition model generation apparatus 20 according to the first example embodiment except that the second voice recognition model 52 is trained by use of training data generated by the training data generation apparatus 10 according to the second example embodiment.

A hardware configuration of a computer that achieves the training data generation apparatus 10 according to the present example embodiment is shown by, for example, FIG. 7, similarly to the training data generation apparatus 10 according to the first example embodiment. Moreover, a hardware configuration of a computer that achieves the voice recognition model generation apparatus 20 according to the present example embodiment is shown by, for example, FIG. 7, similarly to the voice recognition model generation apparatus 20 according to the first example embodiment. However, the storage device 1080 of the computer 1000 that achieves the training data generation apparatus 10 according to the present example embodiment further stores a program module that achieves the determination unit 180 of the training data generation apparatus 10 according to the present example embodiment.

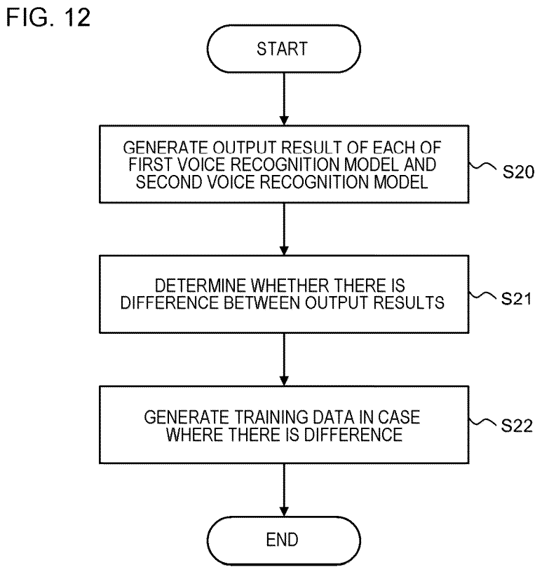

FIG. 12 is a diagram illustrating an outline of a training data generation method according to the present example embodiment. The training data generation method according to the present example embodiment is executed by one or more computers. The training data generation method according to the present example embodiment includes a voice recognition step S20, a determination step S21, and a generation step S22. The voice recognition step S20 inputs voice data into each of an already trained first voice recognition model and a second voice recognition model, and thereby generates an output result of each of the first voice recognition model and the second voice recognition model. The determination step S21 determines whether there is a difference between the output result of the first voice recognition model and the output result of the second voice recognition model. The generation step S22 generates training data including the voice data in a case where it is determined that there is a difference between the output result of the first voice recognition model and the output result of the second voice recognition model.

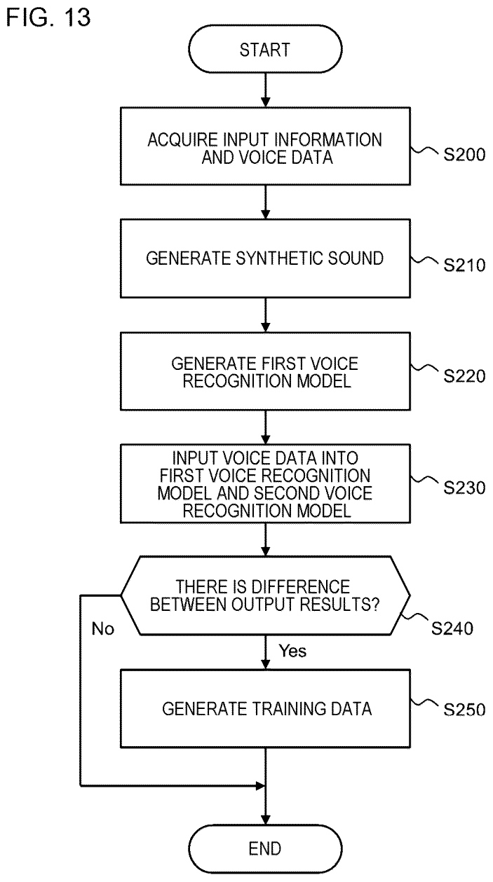

FIG. 13 is a flowchart illustrating a flow of the training data generation method according to the present example embodiment. Each of pieces of processing from S200 to S220 is the same as each of pieces of the processing from S100 to S120 according to the first example embodiment. In the training data generation method according to the present example embodiment, following S220, the voice recognition unit 140 inputs voice data into each of the first voice recognition model 51 and the second voice recognition model 52, and thereby generates text information being an output result of each voice recognition model (S230). Then, the determination unit 180 determines whether there is a difference between an output result of the first voice recognition model 51 and an output result of the second voice recognition model 52 (S240). In a case where it is determined in S240 that there is a difference (Yes in S240), the generation unit 160 generates training data including voice data (S250). Then, processing relating to the voice data ends. On the other hand, in a case where it is determined in S240 that there is no difference (No in S240), no training data are generated, and processing relating to the voice data ends. Processing from S200 to S250 is performed, for example, for each piece of voice data.

A modified example of a method in which the determination unit 180 determines whether there is a difference between an output result of the first voice recognition model 51 and an output result of the second voice recognition model 52 is described below.

The determination unit 180 may determine whether there is a difference between an output result of the first voice recognition model 51 and an output result of the second voice recognition model 52, with a criterion of whether a target word is included in each of the output result of the first voice recognition model 51 and the output result of the second voice recognition model 52, instead of determining whether an output result of the first voice recognition model 51 and an output result of the second voice recognition model 52 match. The target word is, for example, one or more of contents of a plurality of items included in input information. Preferably, the target word is all contents of a plurality of items included in input information. The determination unit 180 can determine a target word by use of information indicating an item previously determined to be a target word, and input information acquired by the acquisition unit 110.

In the present modified example, in a case where there is a difference in a recognition result of a target word, the determination unit 180 determines that there is a difference between an output result of the first voice recognition model 51 and an output result of the second voice recognition model 52. Specifically, the determination unit 180 detects one or more target words included in text information being the output result of the first voice recognition model 51. Moreover, the determination unit 180 detects one or more target words included in text information being the output result of the second voice recognition model 52. Then, in a case where the one or more target words detected in the output result of the first voice recognition model 51 and the one or more target words detected in the output result of the second voice recognition model 52 all match, the determination unit 180 determines that there is no difference between the output result of the first voice recognition model 51 and the output result of the second voice recognition model 52. Then, in a case where the one or more target words detected in the output result of the first voice recognition model 51 and the one or more target words detected in the output result of the second voice recognition model 52 do not match, it is determined that there is a difference between the output result of the first voice recognition model 51 and the output result of the second voice recognition model 52.

For example, it is assumed that target words are a word A, a word B, and a word C. Herein, in a case where the word A, the word B, and the word C are detected in the output result of the first voice recognition model 51, and only the word A and the word B are detected in the output result of the second voice recognition model 52, the determination unit 180 determines that there is a difference between the output results.

As another example, in a case where there are a plurality of target words, the determination unit 180 may determine whether there is a difference between two output results by comparing the number of detected target words. That is to say, in a case where the number of target words detected in the output result of the first voice recognition model 51 and the number of target words detected in the output result of the second voice recognition model 52 match, the determination unit 180 determines that there is no difference between the output result of the first voice recognition model 51 and the output result of the second voice recognition model 52. On the other hand, in a case where the number of target words detected in the output result of the first voice recognition model 51 and the number of target words detected in the output result of the second voice recognition model 52 do not match, the determination unit 180 determines that there is a difference between the output result of the first voice recognition model 51 and the output result of the second voice recognition model 52.

Note that, in a case where at least one of (1) to (3) below holds true, the determination unit 180 may output, to the generation unit 160, determination result information indicating that there is no need to generate training data.
(1) At least one target word is detected only in an output result of the second voice recognition model 52
(2) The number of target words detected in an output result of the second voice recognition model 52 is larger than the number of target words detected in the output result of the first voice recognition model 51
(3) None of target words are detected in both an output result of the first voice recognition model 51 and an output result of the second voice recognition model 52

Next, an advantage and an effect according to the present example embodiment are described. In the present example embodiment, an advantage and an effect similar to those according to the first example embodiment can be acquired. In addition, the determination unit 180 determines whether there is a difference between an output result of a first voice recognition model and an output result of a second voice recognition model, and, thereby, training data that enable efficient training are generated.

The example embodiments according to the present invention have been described above with reference to the drawings, but are exemplifications of the present invention, and various configurations other than those described above can also be adopted.

Moreover, although a plurality of steps (pieces of processing) are described in order in a plurality of flowcharts used in the above description, an execution order of steps executed in each example embodiment is not limited to the described order. In each example embodiment, an order of illustrated steps can be changed to an extent that causes no problem in terms of content. Moreover, the example embodiments described above can be combined to an extent that content does not contradict.

Some or all of the above-described example embodiments can also be described as, but are not limited to, the following supplementary notes.
1-1. A training data generation apparatus including:
   a voice recognition unit that generates text information by inputting voice data into an already trained first voice recognition model; and
   a generation unit that generates training data including the voice data and the text information, in which
   the first voice recognition model is a model that has been trained by use of a synthetic sound generated by use of input information relating to a predetermined item and previously prepared formatted text information.
1-2. The training data generation apparatus according to supplementary note 1-1, further including
   an acquisition unit that acquires the input information and the voice data that are associated with each other.
1-3. The training data generation apparatus according to supplementary note 1-2, in which
   the acquisition unit acquires a plurality of pieces of the voice data,
   the training data generation apparatus further including
   a first model generation unit that generates the first voice recognition model for each piece of the voice data.
1-4. The training data generation apparatus according to supplementary note 1-3, in which
   the first model generation unit generates the first voice recognition model by training a second voice recognition model by use of the synthetic sound.
2-1. A training data generation apparatus including:
   a voice recognition unit that inputs voice data into each of an already trained first voice recognition model and a second voice recognition model, and thereby generates an output result of each of the first voice recognition model and the second voice recognition model;
   a determination unit that determines whether there is a difference between the output result of the first voice recognition model and the output result of the second voice recognition model; and
   a generation unit that generates training data including the voice data in a case where the determination unit determines that there is a difference between the output result of the first voice recognition model and the output result of the second voice recognition model.
2-2. The training data generation apparatus according to supplementary note 2-1, further including
   a first model generation unit that generates the first voice recognition model by training the second voice recognition model by use of a synthetic sound.
2-3. The training data generation apparatus according to supplementary note 2-2, in which
   the synthetic sound is a sound generated by use of input information relating to a predetermined item and previously prepared formatted text information.
2-4. The training data generation apparatus according to supplementary note 2-2 or 2-3, further including
   an acquisition unit that acquires the input information and the voice data that are associated with each other.
2-5. The training data generation apparatus according to supplementary note 2-4, in which
   the acquisition unit acquires a plurality of pieces of the voice data, and
   the first model generation unit generates the first voice recognition model for each piece of the voice data.
2-6. The training data generation apparatus according to any one of supplementary notes 2-2 to 2-5, in which
   the generation unit generates training data including an output result of the first voice recognition model and the voice data in a case where the determination unit determines that there is a difference between an output result of the first voice recognition model and an output result of the second voice recognition model.
3-1. A voice recognition model generation apparatus including
   training the second voice recognition model by use of the training data generated by the training data generation apparatus according to any one of supplementary notes 1-4, and 2-1 to 2-6.
4-1. A training data generation method including,
   by one or more computers:
      generating text information by inputting voice data into an already trained first voice recognition model; and
      generating training data including the voice data and the text information, in which
   the first voice recognition model is a model that has been trained by use of a synthetic sound generated by use of input information relating to a predetermined item and previously prepared formatted text information.
4-2. The training data generation method according to supplementary note 4-1, further including,
   by the one or more computers,
   acquiring the input information and the voice data that are associated with each other.
4-3. The training data generation method according to supplementary note 4-2, further including,
   by the one or more computers:
      acquiring a plurality of pieces of the voice data; and
      further generating the first voice recognition model for each piece of the voice data.
4-4. The training data generation method according to supplementary note 4-3, in which
   by the one or more computers,
   the first voice recognition model is generated by training a second voice recognition model by use of the synthetic sound.
5-1. A training data generation method including,
   by one or more computers:
      inputting voice data into each of an already trained first voice recognition model and a second voice recognition model, and thereby generating an output result of each of the first voice recognition model and the second voice recognition model;
      determining whether there is a difference between the output result of the first voice recognition model and the output result of the second voice recognition model; and
      generating training data including the voice data in a case where it is determined that there is a difference between the output result of the first voice recognition model and the output result of the second voice recognition model.
5-2. The training data generation method according to supplementary note 5-1, further including,
   by the one or more computers,
   generating the first voice recognition model by training the second voice recognition model by use of a synthetic sound.
5-3. The training data generation method according to supplementary note 5-2, in which
   the synthetic sound is a sound generated by use of input information relating to a predetermined item and previously prepared formatted text information.
5-4. The training data generation method according to supplementary note 5-2 or 5-3, further including,
   by the one or more computers,
   acquiring the input information and the voice data that are associated with each other.
5-5. The training data generation method according to supplementary note 5-4, further including,
   by the one or more computers:
      acquiring a plurality of pieces of the voice data; and
      generating the first voice recognition model for each piece of the voice data.
5-6. The training data generation method according to any one of supplementary notes 5-2 to 5-5, further including,
   by the one or more computers,
   generating training data including an output result of the first voice recognition model and the voice data in a case where it is determined that there is a difference between an output result of the first voice recognition model and an output result of the second voice recognition model.
6-1. A voice recognition model generation method including,
   by one or more computers,
   training the second voice recognition model by use of the training data generated by the training data generation method according to any one of supplementary notes 4-4, and 5-1 to 5-6.
7-1. A program causing a computer to function as a training data generation apparatus, the training data generation apparatus including:
   a voice recognition unit that generates text information by inputting voice data into an already trained first voice recognition model; and
   a generation unit that generates training data including the voice data and the text information,
   in which the first voice recognition model is a model that has been trained by use of a synthetic sound generated by use of input information relating to a predetermined item and previously prepared formatted text information.
7-2. The program according to supplementary note 7-1, the training data generation apparatus further including an acquisition unit that acquires the input information and the voice data that are associated with each other.
7-3. The program according to supplementary note 7-2, in which
   the acquisition unit acquires a plurality of pieces of the voice data,
   the training data generation apparatus further including a first model generation unit that generates the first voice recognition model for each piece of the voice data.
7-4. The program according to supplementary note 7-3, in which
   the first model generation unit generates the first voice recognition model by training a second voice recognition model by use of the synthetic sound.
8-1. A program causing a computer to function as a training data generation apparatus, the training data generation apparatus including:
   a voice recognition unit that inputs voice data into each of an already trained first voice recognition model and a second voice recognition model, and thereby generates an output result of each of the first voice recognition model and the second voice recognition model;
   a determination unit that determines whether there is a difference between the output result of the first voice recognition model and the output result of the second voice recognition model; and
   a generation unit that generates training data including the voice data in a case where the determination unit determines that there is a difference between the output result of the first voice recognition model and the output result of the second voice recognition model.
8-2. The program according to supplementary note 8-1,
   the training data generation apparatus further including a first model generation unit that generates the first voice recognition model by training the second voice recognition model by use of a synthetic sound.
8-3. The program according to supplementary note 8-2, in which
   the synthetic sound is a sound generated by use of input information relating to a predetermined item and previously prepared formatted text information.
8-4. The program according to supplementary note 8-2 or 8-3,
   the training data generation apparatus further including an acquisition unit that acquires the input information and the voice data that are associated with each other.
8-5. The program according to supplementary note 8-4, in which
   the acquisition unit acquires a plurality of pieces of the voice data, and
   the first model generation unit generates the first voice recognition model for each piece of the voice data.
8-6. The program according to any one of supplementary notes 8-2 to 8-5, in which
   the generation unit generates training data including an output result of the first voice recognition model and the voice data in a case where the determination unit determines that there is a difference between an output result of the first voice recognition model and an output result of the second voice recognition model.
9-1. A program causing a computer to function as a voice recognition model generation apparatus, in which
   the voice recognition model generation apparatus trains the second voice recognition model by use of the training data generated by the training data generation apparatus achieved by the program according to any one of supplementary notes 7-4, and 8-1 to 8-6.
10-1. A computer-readable medium storing a program, the program causing a computer to function as a training data generation apparatus, the training data generation apparatus including:
   a voice recognition unit that generates text information by inputting voice data into an already trained first voice recognition model; and
   a generation unit that generates training data including the voice data and the text information,
   in which the first voice recognition model is a model that has been trained by use of a synthetic sound generated by use of input information relating to a predetermined item and previously prepared formatted text information.
10-2. The medium according to supplementary note 10-1, the training data generation apparatus further including an acquisition unit that acquires the input information and the voice data that are associated with each other.
10-3. The medium according to supplementary note 10-2, in which
   the acquisition unit acquires a plurality of pieces of the voice data,
   the training data generation apparatus further including a first model generation unit that generates the first voice recognition model for each piece of the voice data.
10-4. The medium according to supplementary note 10-3, in which
   the first model generation unit generates the first voice recognition model by training a second voice recognition model by use of the synthetic sound.
11-1. A computer-readable medium storing a program, the program causing a computer to function as a training data generation apparatus, the training data generation apparatus including:
   a voice recognition unit that inputs voice data into each of an already trained first voice recognition model and a second voice recognition model, and thereby generates an output result of each of the first voice recognition model and the second voice recognition model;
   a determination unit that determines whether there is a difference between the output result of the first voice recognition model and the output result of the second voice recognition model; and
   a generation unit that generates training data including the voice data in a case where the determination unit determines that there is a difference between the output result of the first voice recognition model and the output result of the second voice recognition model.
11-2. The medium according to supplementary note 11-1, the training data generation apparatus further including a first model generation unit that generates the first voice recognition model by training the second voice recognition model by use of a synthetic sound.
11-3. The medium according to supplementary note 11-2, in which
   the synthetic sound is a sound generated by use of input information relating to a predetermined item and previously prepared formatted text information.
11-4. The medium according to supplementary note 11-2 or 11-3, the training data generation apparatus further including an acquisition unit that acquires the input information and the voice data that are associated with each other.
11-5. The medium according to supplementary note 11-4, in which
   the acquisition unit acquires a plurality of pieces of the voice data, and
   the first model generation unit generates the first voice recognition model for each piece of the voice data.
11-6. The medium according to any one of supplementary notes 11-2 to 11-5, in which
   the generation unit generates training data including an output result of the first voice recognition model and the voice data in a case where the determination unit determines that there is a difference between an output result of the first voice recognition model and an output result of the second voice recognition model.
12-1. A computer-readable medium storing a program, the program causing a computer to function as a voice recognition model generation apparatus, in which
   the voice recognition model generation apparatus trains the second voice recognition model by use of the training data generated by the training data generation apparatus achieved by the program recorded in the medium according to any one of supplementary notes 10-4, and 11-1 to 11-6.

This application is based upon and claims the benefit of priority from Japanese patent application No. 2022-107582, filed on Jul. 4, 2022, the disclosure of which is incorporated herein in its entirety by reference.

### REFERENCE SIGNS LIST

10 Training data generation apparatus
20 Voice recognition model generation apparatus
51 First voice recognition model
52 Second voice recognition model
110 Acquisition unit
120 First model generation unit
121 Text generation unit for a synthetic sound
122 Synthetic sound generation unit
123 First training unit
130 Formatted text storage unit
140 Voice recognition unit
150 Model storage unit
160 Generation unit
170 Training data storage unit
180 Determination unit
220 Second training unit
1000 Computer
1020 Bus
1040 Processor
1060 Memory
1080 Storage device
1100 Input/output interface
1120 Network interface

What is claimed is:

1. A training data generation apparatus comprising:
at least one memory storing instructions; and
at least one processor configured to execute the instructions to perform operations comprising:
generating a text information by inputting voice data into an already trained first voice recognition model; and
generating training data comprising the voice data and the text information, wherein
the first voice recognition model is a model that has been trained by use of a synthetic sound generated by use of input information relating to a predetermined item and previously prepared formatted text information.

2. The training data generation apparatus according to claim 1, wherein
the operations further comprise acquiring the input information and the voice data that are associated with each other.

3. The training data generation apparatus according to claim 2, wherein
acquiring the input information and the voice data comprises acquiring a plurality of pieces of the voice data, and
the operations further comprise generating the first voice recognition model for each piece of the voice data.

4. The training data generation apparatus according to claim 3, wherein
generating the first voice recognition model comprises generating the first voice recognition model by training a second voice recognition model by use of the synthetic sound.

5-11. (canceled)

12. A training data generation method comprising,
by one or more computers:
generating text information by inputting voice data into an already trained first voice recognition model; and
generating training data comprising the voice data and the text information, wherein
the first voice recognition model is a model that has been trained by use of a synthetic sound generated by use of input information relating to a predetermined item and previously prepared formatted text information.

13. The training data generation method according to claim 12, further comprising,
by the one or more computers,
acquiring the input information and the voice data that are associated with each other.

14. The training data generation method according to claim 13,
wherein acquiring the input information and the voice data comprises acquiring a plurality of pieces of the voice data, and
the training data generation method further comprises, by the one or more computers, generating the first voice recognition model for each piece of the voice data.

15. The training data generation method according to claim 14, wherein
generating the first voice recognition model comprises generating the first voice recognition model by training a second voice recognition model by use of the synthetic sound.

16-22. (canceled)

23. A non-transitory computer-readable medium storing a program causing a computer to execute a control method, the control method comprising:
generating text information by inputting voice data into an already trained first voice recognition model; and
generating training data comprising the voice data and the text information,
wherein the first voice recognition model is a model that has been trained by use of a synthetic sound generated by use of input information relating to a predetermined item and previously prepared formatted text information.

24. The medium according to claim 23, wherein
the control method further comprises acquiring the input information and the voice data that are associated with each other.

25. The medium according to claim 24, wherein
acquiring the input information and the voice data comprises acquiring a plurality of pieces of the voice data, and
the control method further comprises generating the first voice recognition model for each piece of the voice data.

26. The medium according to claim 25, wherein
generating the first voice recognition model comprises generating the first voice recognition model by training a second voice recognition model by use of the synthetic sound.

27-33. (canceled)
